(19) United States
(12) Patent Application Publication
(10) Pub. No.: US 2026/0251277 A1
(43) Pub. Date: Aug. 27, 2026

(54) LIGHTING DEVICE FOR A MOTOR VEHICLE

(71) Applicant: HELLA GMBH & CO. KGAA, Lippstadt (DE)

(72) Inventors: Julian Grote, Borchen (DE); Konrad Hesse, Geseke (DE); Martin Mügge, Geseke (DE); Julian Schwinn, Soest (DE)

(21) Appl. No.: 19/544,379

(22) Filed: Feb. 19, 2026

(30) Foreign Application Priority Data
Feb. 21, 2025 (DE) 102025106706.6

(51) Int. Cl. F21S 41/24; B29D 11/00; F21S 41/141; F21S 41/20; F21S 41/29; F21S 41/37

(52) U.S. Cl. CPC F21S 41/24; B29D 11/00663; F21S 41/2805; F21S 41/29; F21S 41/37; F21S 41/141

(57) ABSTRACT

The present invention relates to a lighting device for a motor vehicle. The lighting device includes at least one light source, a planar light guide having at least one entry surface, at least one exit surface, at least one optical component, and a cover lens. The lighting device is configured such that the light generated by the at least one light source enters the light guide at least partially through the at least one entry surface, that the light entering through the at least one entry surface exits at least partially from the at least one exit surface, the light emerging from the at least one exit surface of the light guide either at least partially passes through the at least one optical component, is reflected by the at least one optical component, or both at least partially passes through and is reflected by the at least one optical component, and that the light exiting from the at least one exit surface of the light guide at least partially exits from the lighting device through the cover lens. The light guide has curvatures in two different directions.

### CROSS-REFERENCE TO RELATED APPLICATIONS

This application claims the benefit of German Patent Application 10-2025-106-706.6, filed Feb. 21, 2025, the disclosure of which is incorporated by reference in its entirety.

### FIELD OF THE INVENTION

The present invention relates to a lighting device for a motor vehicle, a method for manufacturing a light guide, and a method for manufacturing a tool insert of an injection molding tool.

### BACKGROUND OF THE INVENTION

Design has long been a determining factor for the signal functions of a motor vehicle, such as a tail light, a brake light, a turn signal, or a daytime running light, in rear lamps or in headlamps. The design of these lighting devices has become even more significant since the introduction of LED technology, because the small light-emitting diodes, which are often used in larger numbers, can be used as a light source for a signal function much more flexibly than a large incandescent lamp, so that a wide variety of design options are available in conjunction with the selected optical system.

A variant of LED technology is found in the form of OLED technology, in which the light source is not small and point-like as a light-emitting diode, but rather designed to be planar and larger to form a desired light-emitting surface that can be illuminated very homogeneously. A disadvantage of OLED technology is the significantly higher cost of OLED technology compared to LED technology. The reasons for these high costs are a complex manufacturing process, the different shapes dictated by the design and small quantities. In addition, there are specific, high requirements in the automotive sector, such as resistance to UV exposure and the effects of forces such as vibrations, impacts, and shaking, as well as temperature resistance in a range between −40° C. and +85° C. or +100° C. These requirements are substantially more difficult to meet for an organic light-emitting diode than for standard light-emitting diodes.

As a result, alternative options are being sought to achieve a design similar to that of organic light-emitting diodes (OLEDs), in particular a homogeneously illuminated surface. This is achieved by using light-emitting diodes (LEDs) with a planar light guide and upstream optics in the form of microstructured films or thin optical disks, to scatter the light emitted from the light guide. Overall, this provides a flat light module that offers high performance with homogeneous illumination of the entire surface.

Just as with organic light-emitting diodes, several flat light modules can then be positioned offset next to and behind one another when integrated into a rear lamp, in order to create the desired individual appearance of the signal function, for example, of the tail light or the tail/brake light. Finally, a flat light module instead of individual modules can also be designed as a large flat lighting element. As such a flat lighting device, it can also be used to backlight displays.

A lighting device of the type mentioned at the beginning, designed as a flat light module, is known from DE 10-2022-113-052 A1. The lighting device described therein comprises at least one light source designed as a light-emitting diode (LED) and a flat light guide with an entry surface and at least one exit surface, the entry surface being designed as the front surface of the light guide. The lighting device further comprises at least one optical disk. The lighting device is configured such that the light generated by the at least one light source enters the light guide at least partially through the entry surface, so that the light that has entered through the entry surface exits at least partially from the at least one exit surface, and so that the light exiting from the at least one exit surface of the light guide passes at least partially through the at least one optical disk. In this case, the flat light module can have LEDs of different colors, such as red, yellow, or white, in order to achieve a combination of signal functions, such as a tail/brake/turn light or an additional reverse light.

An exemplary lighting device designed as a flat-light module according to this prior art is shown in FIG. 16 and FIG. 17. This flat light module comprises a light source 1 that has several light-emitting diodes (LEDs). The flat light module also comprises a housing 2 with a rear housing part and a front housing part 2a, 2b, which are connected to one another by a latching mechanism. A plate-shaped light guide 3 with micro-optics, a white, diffusely reflective film 4 behind the light guide 3, and two or three optical components 5a, 5b designed as micro-optical films in front of the light guide 3 are inserted between the housing parts 2a, 2b, which together are responsible for the light distribution and efficiency of the system by coordinating the individual micro-optical components with one another. The principle of this basic structure is to provide a lighting element with a uniform, homogeneously illuminated surface. For this purpose, the lighting device comprises a cover lens 6, which serves as the illuminated exit surface of the lighting device.

The optical component 5a adjacent to the light guide 3 is designed as a diffuser, whereas the second optical component 5b is designed as a so-called BEF optical system. BEF in this context means “Brightness Enhancement Film”. The BEF optics therefore serve to increase the brightness of the light passing through the optical component 5b. The BEF optics can be realized on a film or also as a thin injection-molded optical disk. Systems with two BEF optics, oriented orthogonally to one another, can also be provided, wherein the diffuser optics are sometimes omitted.

In the prior art, flat light modules of this type are intended to form a completely luminous, one-piece surface as a module of a small size or any desired size up to a larger surface of a rear lamp or of the entire rear lamp. With flat light modules from the prior art, the focus of implementation is primarily on planar luminous surfaces or surfaces with a slight curvature in one direction, such as a cylindrical surface.

One of the reasons for this is that the light guide of flat light modules usually has a structure on a surface opposite the exit surface. If the light guide is then to be manufactured as a plastic component by an injection molding process, a corresponding structuring must be introduced into a tool insert of the injection mold, which is usually done by exposure to laser radiation. These structures can only be introduced into the tool insert with existing devices for laser irradiation on planar surfaces or surfaces that are slightly curved in one direction. Applications such as OLED elements or flat light modules have thus far been implemented essentially as planar elements, because the technologies used have not yet made it possible to provide them as curved elements.

On the other hand, it should be noted that virtually no planar surfaces are used in lighting systems in the automotive environment. It is therefore desirable in vehicle and lighting design to design such lighting elements as curved surfaces.

### SUMMARY OF THE INVENTION

The problem underlying the present invention is the creation of a lighting device of the type mentioned in the beginning, in which a light guide of the lighting device has such a curvature, so that simpler integration of the lighting device into a curved design of the motor vehicle is made possible. Furthermore, a method of the type mentioned in the beginning for manufacturing a light guide and a method of the type mentioned in the beginning for manufacturing a tool insert are to be specified.

This is achieved by a lighting device of the type mentioned in the beginning with the characterizing features of the current embodiments, by a method of the type mentioned in the beginning for manufacturing a light guide with the characterizing features of the current embodiments, and by a method of the type mentioned in the beginning for manufacturing a tool insert with the characterizing features of the current embodiments.

In one embodiment, it is provided that the light guide has bends in two different directions, in particular in two mutually perpendicular directions. In particular, the surface of the light guide can be curved at least in sections in two different directions, especially in two mutually perpendicular directions. This results in a three-dimensionally curved surface, which makes it easier to integrate the lighting device into a curved design of the motor vehicle.

It is possible for the light guide to have a structuring, in particular a micro-optical structuring, on its surface opposite the at least one exit surface, which can cause or amplify a decoupling of the light entering through the at least one entry surface from the at least one exit surface. In this case, the structuring can have a density distribution, wherein the density of the structuring on the surface opposite the at least one exit surface increases with increasing distance from the at least one entry surface. Such a design ensures that a uniform intensity of the decoupled light is achieved over the longitudinal extent of the light guide.

It may be provided that the light guide is substantially U-shaped, at least in sections, wherein the light guide has two U-legs and a connecting portion that connects the U-legs to one another, in particular, wherein the two U-legs are spaced apart from one another. In this case, each of the U-legs of the light guide can have, in sections, a longitudinal direction and a transverse direction perpendicular thereto, as well as a depth perpendicular to the longitudinal direction and to the transverse direction, in particular, wherein each of the U-legs of the light guide has a greater extent in the longitudinal direction than in the transverse direction and a greater extent in the transverse direction than in the depth perpendicular to the transverse direction, so that each of the U-legs of the light guide has an end surface at the end in the longitudinal direction, two narrow surfaces extending in sections in the longitudinal direction, and two wide surfaces extending in sections in the longitudinal direction.

It is possible for the light guide to have at least two entry surfaces, wherein at least one of the entry surfaces is arranged on each of the U-legs. In this case, one of the entry surfaces can be arranged in each case on the end surface of the U-leg facing away from the connecting portion and/or one of the entry surfaces can be arranged in each case on the narrow surfaces extending in the longitudinal direction of the U-leg. Depending on the desired design, the shape, and the size of the exit surface of the light guide, one of the two possibilities for coupling can be selected. In particular, it is also possible to arrange entry surfaces for the light to be coupled into the light guide both on the end surfaces of the U-legs facing away from the connecting portion and on the narrow surfaces of the U-legs extending in the longitudinal direction of the U-leg.

It may be provided that the at least one optical component is designed as a microstructured film and/or as a microstructured optical disk, wherein the at least one microstructured film or the at least one microstructured optical disk is arranged in particular between the light guide and the cover lens. Furthermore, it may be provided that the light guide has at least two exit surfaces, wherein a first of the exit surfaces faces away from the cover lens and a second of the exit surfaces faces the cover lens. In this case, the at least one optical component can be designed as an at least partially reflective surface that is arranged on the side of the light guide facing away from the cover lens, wherein the lighting device is configured such that light exiting from the first exit surface of the light guide strikes the reflective surface, is reflected back from it to the first exit surface, and at least partially re-enters the light guide before it exits from the second exit surface and passes through the at least one cover lens. In this way, as with a flat light module, the lighting device can provide high performance with homogeneous illumination of the cover lens by reflecting the light exiting from the light guide at the rear and/or by targeted scattering on the microstructured films and/or optical discs.

According to another embodiment, it is provided that the light guide is manufactured by a plastic injection molding process in an injection mold with a tool insert.

According to yet another embodiment, it is provided that the tool insert is exposed to laser radiation in order to generate a structuring of the tool insert that serves to manufacture the micro-optical structuring on the surface opposite the exit surface of the light guide. The tool insert can be aligned and pivoted during exposure to laser radiation in order to allow the laser radiation to impinge on the surface of the tool insert to be processed at an angle of less than 10° to the normal, in particular at an angle of less than 5° to the normal, preferably substantially parallel to the normal. Alternatively or additionally, the laser radiation can be deflected before impinging on the tool insert in order to allow the laser beam to impinge on the surface of the tool insert to be processed at an angle of less than 10° to the normal, in particular at an angle of less than 5° to the normal, preferably substantially parallel to the normal. Both measures can be used to achieve the desired structuring of the tool insert, which is used to manufacture the micro-optical structuring on the surface opposite the exit surface of the light guide, despite the curvatures of the light guide in two different directions.

### BRIEF DESCRIPTION OF THE DRAWINGS

The invention is explained in more detail below, with reference to the accompanying figures. In the figures:

FIG. 1 is a front view of a lighting device according to an embodiment of the invention, in which different light functions are indicated;

FIG. 2 is a sectional view through the lighting device according to FIG. 1;

FIG. 3 is a front view of the parts of the lighting device according to FIG. 1 that generate the signal function;

FIG. 4 is a perspective view of the parts of the lighting device according to FIG. 1 that generate the signal function;

FIG. 5 is a top view of the parts of the lighting device according to FIG. 1 that generate the signal function;

FIG. 6 is a rear view of the parts of the lighting device according to FIG. 1 that generate the signal function;

FIG. 7 is a rear view of the parts of the lighting device according to FIG. 1 that generate the signal function, with a cover lens and a housing;

FIG. 8 is a rear view of the parts of the lighting device according to FIG. 1 that generate the signal function, with the cover lens, the housing, and a rear cover;

FIG. 9 is a top view, corresponding to FIG. 5, of the parts of the lighting device according to FIG. 1 that generate the signal function, with a density distribution of a structuring;

FIG. 10 is a perspective view of the light guide of the lighting device according to FIG. 1;

FIG. 11 is a detailed view according to arrow XI in FIG. 10;

FIG. 12 is a detailed view according to arrows XII in FIG. 10;

FIG. 13 is a front view, corresponding to FIG. 5, of the parts generating the signal function of a lighting device according to an embodiment of the invention;

FIG. 14 is a sectional view through an injection mold with a light guide of a lighting device according to an embodiment of the invention;

FIG. 15 is a sectional view through a tool insert of the injection mold according to FIG. 14 with laser beams shown;

FIG. 16 is a perspective view of a lighting device according to the prior art; and

FIG. 17 is an exploded view of the lighting device according to FIG. 16.

In the figures, identical or functionally identical parts are indicated with the same reference symbols.

### DETAILED DESCRIPTION OF THE CURRENT EMBODIMENTS

The illustrated embodiments of a lighting device are designed as headlamps of a motor vehicle. However, it is also possible to use similar geometries in the same way for rear lamps or interior lights.

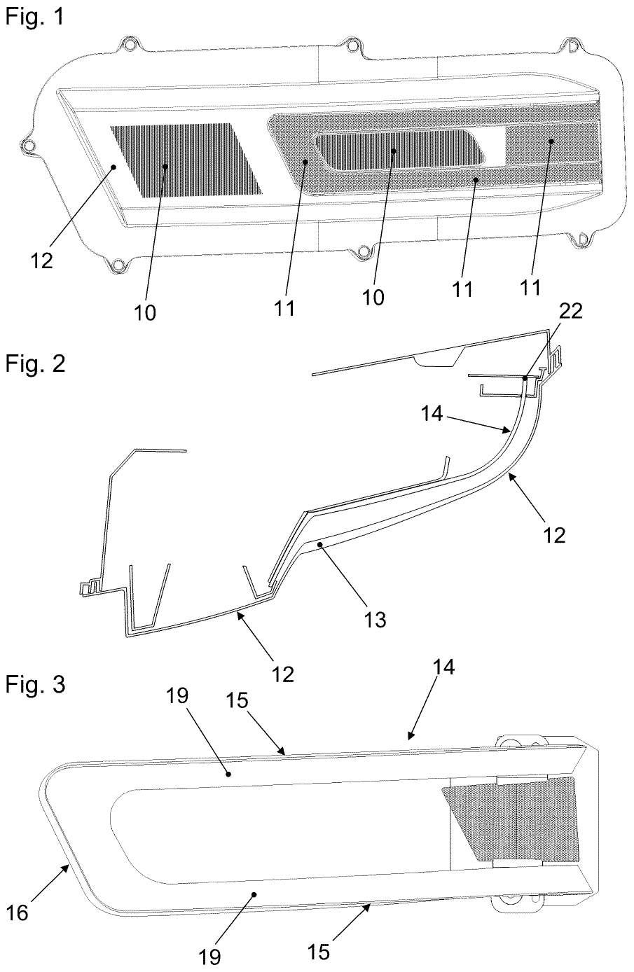

In the lighting device designed as a headlamp, regions 10 are provided for the main light functions of low beam and high beam, and regions 11 are provided for the signal functions of a common position light, daytime running light, and turn signal (see FIG. 1).

The lighting device comprises a cover lens 12, which has a recess 13 in a partial region of the cover lens 12 (see FIG. 2). A light guide 14 is arranged behind the cover lens 12, and runs parallel to the cover lens 12, at least in sections. The light guide 14 has curvatures in two different directions, in particular, in two mutually perpendicular directions.

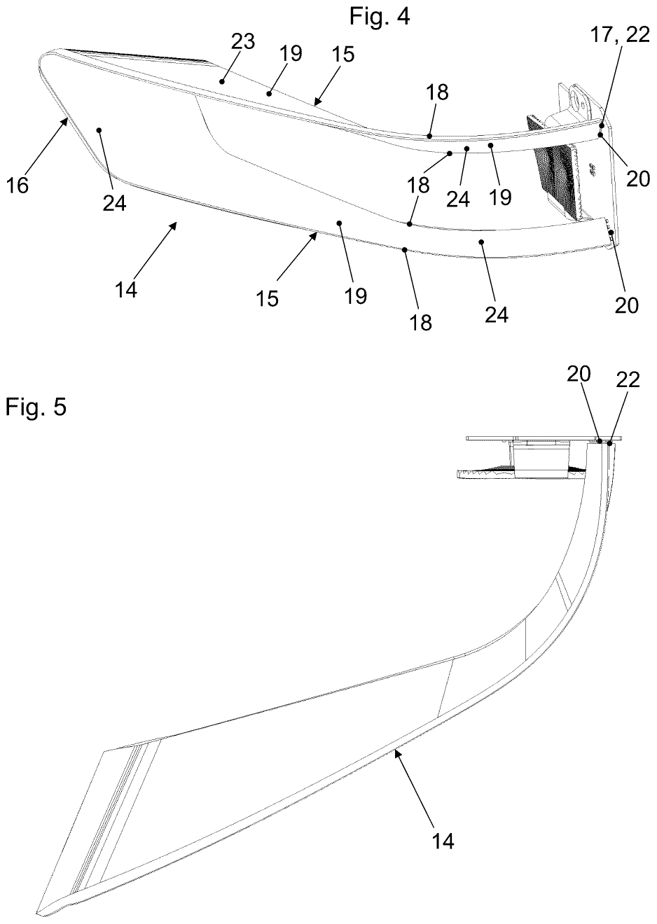

The light guide 14 is designed to be at least substantially in a U-shape, wherein the light guide 14 has two U-legs 15 and a connecting portion 16, which connects the U-legs 15 to each other (see FIG. 3 and FIG. 4). In this case, the two U-legs 15 are spaced apart. Each of the U-legs 15 of the light guide 14 has, in sections, a longitudinal direction and a transverse direction perpendicular thereto, as well as a depth perpendicular to the longitudinal direction and to the transverse direction. Thereby, each of the U-legs 15 of the light guide 14 has a greater extension in the longitudinal direction than in the transverse direction, and a greater extension in the transverse direction than in the depth perpendicular to the transverse direction (see FIG. 4). Therefore, each of the U-legs 15 of the light guide 14 has an end surface 17 at the end in the longitudinal direction, two narrow surfaces 18 extending in sections in the longitudinal direction, and two wide surfaces 19 extending in sections in the longitudinal direction.

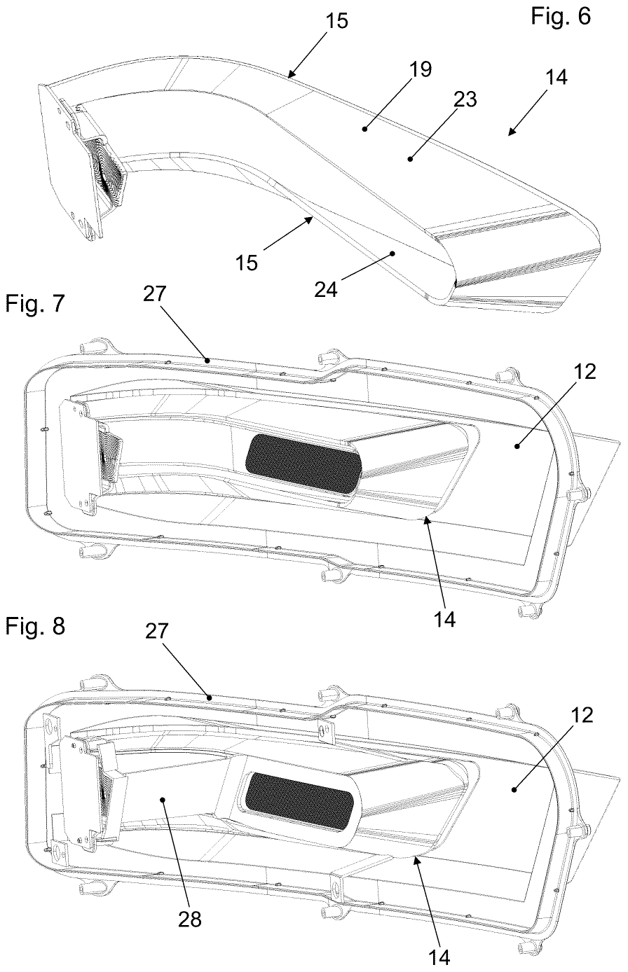

The lighting device has a plurality of light sources 20 in the form of light-emitting diodes (see FIG. 4). The light 21 emitted by these light sources 20 is coupled into the light guide 14. In the embodiment shown in FIG. 1 to FIG. 12, the two end faces 17 of the U-legs 15 serve as entry surfaces 22 for the light 21.

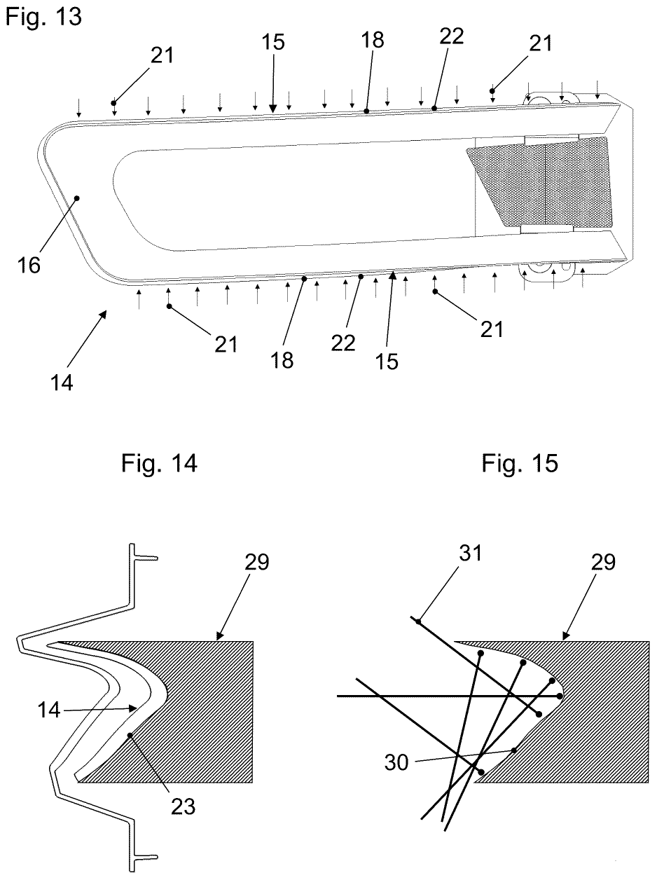

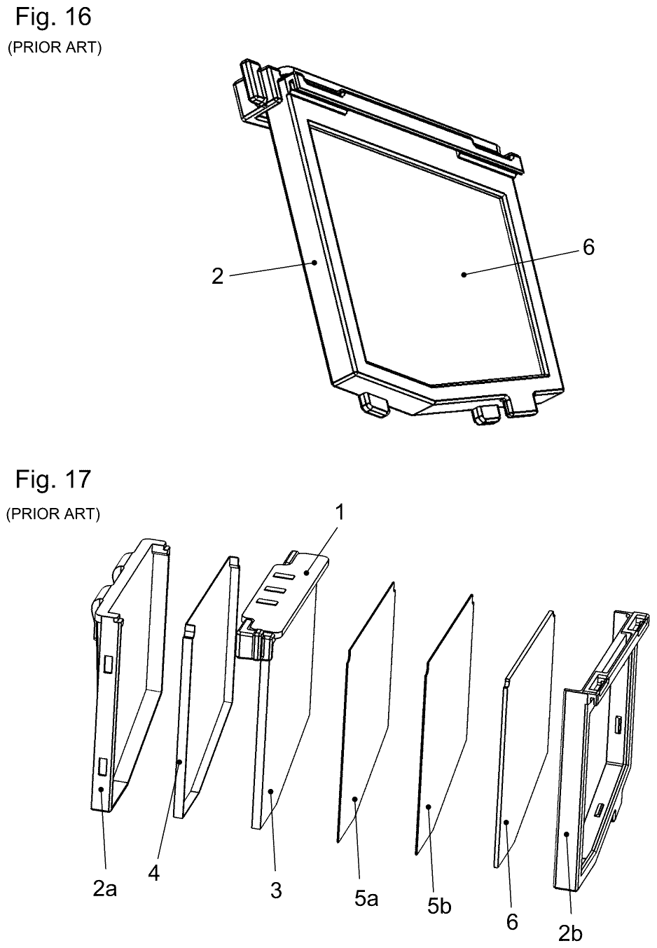

In the embodiment shown in FIG. 13, the two narrow surfaces 18 of the U-legs 15, which extend in sections in the longitudinal direction, serve as entry surfaces 22 for the light 21 emitted by the light sources 20. It is certainly possible to use both the end faces 17 of the U-legs 15 and the narrow surfaces 18 of the U-legs 15 as entry surfaces 22 for the light 21 emitted by the light sources 20.

The light guide has two exit surfaces 23, 24, wherein the first exit surface 23 faces away from the cover lens 12, and the second exit surface 24 faces the cover lens 12. In this case, the wide surfaces 19 of the U-legs 15, which extend in sections in the longitudinal direction, and the front and rear side of the connecting portion 16 serve as exit surfaces 23, 24 for the light 21 coupled into the light guide 14 through the entry surfaces.

A micro-optical structuring 25 is arranged on the first exit surface 23 facing away from the cover lens, which can cause or intensify the decoupling of the light 21 entering through the entry surfaces 22 from the second exit surface 24 (see FIG. 10 to FIG. 12). The structuring 25 has a density distribution 26, wherein the density of the structuring 25 on the first exit surface 23 increases with increasing distance from the entry surfaces 22. In this context, density refers to the number of micro-optics per unit area.

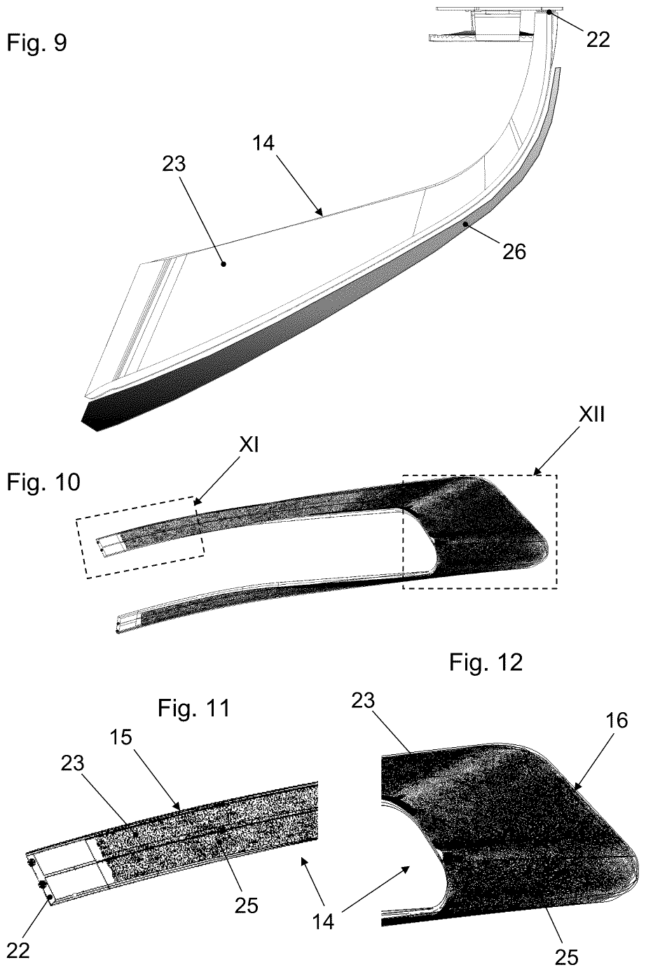

The density distribution 26 is shown schematically in FIG. 9. Furthermore, the density distribution 26 can be seen from a comparison of the detailed view according to FIG. 11, which shows the structuring 25 of the first exit surface 23 in the vicinity of the entry surface 22, with the detailed view according to FIG. 12, which shows the structuring 25 of the first exit surface 23 in the region of the connecting portion 16. The comparison clearly shows that there is initially a lower density of micro-optics in the region of the entry surface 22, which then increases toward the opposite connecting portion 16.

The lighting device also comprises an optional optical component, not shown, which is designed as an at least partially reflective surface. This optical component is arranged on the side of the light guide 14 facing away from the cover lens 12. In this case, the lighting device is configured such that light 21 emitted from the first exit surface 23 of the light guide 14 strikes the reflective surface of the optical component, is reflected back from the latter to the first exit surface 23, and at least partially re-enters the light guide 14 before it emerges from the second exit surface 24 and passes through the cover lens 12.

The lighting device further comprises at least one optional optical component, not shown, which is designed as a microstructured film or as a microstructured optical disk. The at least one microstructured film or the at least one microstructured optical disk is arranged between the light guide 14 and the cover lens 12.

The light sources 20, the light guide 14, and the cover lens 12 and, if necessary, the optical components, are used to generate a signal function, such as a position light, a daytime running light, or a turn signal.

The lighting device further comprises a housing 27, in or on which the light sources 20, the light guide 14, and the cover lens 12 and, if applicable, the optical components, are arranged (see FIG. 7 and FIG. 8). In this case, a rear cover 28 is also provided on the side of the light guide 14 facing away from the cover lens 12.

The light guide 14 is manufactured by a plastic injection molding process in an injection mold with a tool insert 29. FIG. 14 shows an example of a section of a light guide 14 in the tool insert 29 of an injection mold.

In order for the structuring 25 to be produced on the first exit surface 23 of the light guide 14 during the injection molding process, a corresponding surface 30 of the tool insert 29 must have a structure complementary to the structuring 25. To introduce this structure into the surface 30 of the tool insert 29, the surface 30 of the tool insert 29 is exposed to laser radiation 31.

In this case, the geometry of the light guide 14 must be designed in such a way that the surface 30 of the tool insert 29 is basically accessible for laser processing. This means that the curved surface of the light guide 14 may be shaped in such a way that the laser beam 31 for processing the surface 30 of the tool insert 29 is always directed onto the surface 30 in the normal direction or at angles deviating slightly from the normal direction. If the laser radiation 31 were to strike the surface 30 at large angles to the normal, the effective power of the laser radiation would be reduced and would not be sufficient to process the material. As a result, the quality of the structure produced by exposure to laser radiation would be poorer.

Depending on the design of the device used for exposure to laser radiation, it may be possible to align and swivel the tool insert 29 as required in order to always ensure the best possible alignment of the laser radiation.

An additional option for the laser process is that an additional deflection mirror can be provided in the device used for exposure to laser radiation in order to generate a precise deflection and redirection of the laser radiation.

### List of Reference Numbers

1 light source
2 housing
2a, 2b housing part
3 light guide
4 reflective film
5a, 5b optical component designed as a micro-optical film
6 cover lens
10 region for a main light function
11 region for a signal function
12 cover lens
13 recess in the cover lens
14 light guide
15 U-leg of the light guide
16 connecting portion of the light guide
17 end surface of the U-leg
18 narrow surface of the U-leg
19 wide surface of the U-leg
20 light source
21 light emitted by the light source
22 entry surface of the light guide
23 first exit surface of the light guide
24 second exit surface of the light guide
25 structuring on the first exit surface
26 density distribution of the structuring
27 housing
28 rear cover
29 tool insert
30 surface of the tool insert
31 laser radiation

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle, comprising:
at least one light source;
a planar light guide with at least one entry surface and at least one exit surface;
at least one optical component; and
a cover lens, wherein the lighting device is configured such that the light generated by the at least one light source enters the light guide at least partially through the at least one entry surface, the light entering through the at least one entry surface exits at least partially from the at least one exit surface, the light emerging from the at least one exit surface of the light guide either passes, at least partially, through the at least one optical component, is reflected by the at least one optical component, or both passes, at least partially, through the at least one optical component and is reflected by the at least one optical component,
and the light emerging from the at least one exit surface of the light guide emerges, at least partially, from the lighting device through the cover lens, and
wherein the light guide has bends in two different directions.

2. The lighting device according to claim 1, wherein the surface of the light guide is curved at least in sections in two different directions.

3. The lighting device according to claim 1, wherein the light guide has a structuring on its surface opposite the at least one exit surface, configured to cause or amplify a decoupling of the light that has entered through the at least one entry surface from the at least one exit surface.

4. The lighting device according to claim 3, wherein the structuring has a density distribution, wherein the density of the structuring on the surface opposite the at least one exit surface increases with increasing distance from the at least one entry surface.

5. The lighting device according to claim 1, wherein the light guide is substantially U-shaped, at least in sections, wherein the light guide has two U-legs and a connecting portion that connects the U-legs to one another, wherein the two U-legs are spaced apart from one another.

6. The lighting device according to claim 5, wherein each of the U-legs of the light guide has, in sections, a longitudinal direction and a transverse direction perpendicular thereto, as well as a depth perpendicular to the longitudinal direction and to the transverse direction, wherein each of the U-legs of the light guide has a greater extent in the longitudinal direction than in the transverse direction and a greater extent in the transverse direction than in the depth perpendicular to the transverse direction, so that each of the U-legs of the light guide has an end surface at the end in the longitudinal direction, two narrow surfaces extending in sections in the longitudinal direction, and two wide surfaces extending in sections in the longitudinal direction.

7. The lighting device according to claim 5, wherein the light guide has at least two entry surfaces, wherein at least one of the entry surfaces is arranged on each of the U-legs.

8. The lighting device according to claim 7, wherein one of the entry surfaces is arranged in each case either on the end surface of the U-leg facing away from the connecting portion, or on the narrow surfaces of the U-leg extending in the longitudinal direction, or on both the end surface of the U-leg facing away from the connecting portion and on one of the narrow surfaces of the U-leg extending in the longitudinal direction.

9. The lighting device according to claim 1, wherein the at least one optical component is designed as one or both of microstructured film and a microstructured optical disc, wherein the at least one microstructured film or the at least one microstructured optical disc is arranged between the light guide and the cover lens.

10. The lighting device according to claim 1, wherein the light guide has at least two exit surfaces, wherein a first of the exit surfaces faces away from the cover lens and a second of the exit surfaces faces the cover lens.

11. The lighting device according to claim 10, wherein the at least one optical component is designed as an at least partially reflective surface arranged on the side of the light guide facing away from the cover lens, wherein the lighting device is configured such that light emerging from the first exit surface of the light guide impinges on the reflective surface, is reflected back by the latter to the first exit surface, and at least partially re-enters the light guide before it emerges from the second exit surface and passes through the at least one cover lens.

12. A method for manufacturing a light guide of a lighting device according to claim 1, wherein the light guide is manufactured by a plastic injection molding process in an injection mold with a tool insert.

13. A method for manufacturing a tool insert of an injection mold which is used for the method according to claim 12, wherein the tool insert is exposed to laser radiation in order to produce a structuring of the tool insert that serves to produce the micro-optical structuring on the surface opposite the exit surface of the light guide.

14. The method according to claim 13, wherein the tool insert is aligned and pivoted during exposure to laser radiation in order to allow the laser radiation to impinge on the surface of the tool insert to be processed at an angle of less than 10° to the normal.

15. The method according to claim 13, wherein the laser radiation is deflected before impinging on the tool insert in order to cause the laser radiation to impinge on the surface of the tool insert to be processed at an angle of less than 10° to the normal.
